(19) United States
(12) Patent Application Publication
(10) Pub. No.: US 2025/0384259 A1
(43) Pub. Date: Dec. 18, 2025

(54) ANALOG PULSE FREQUENCY NEURAL NETWORK ASIC

(71) Applicants: David Richard Abbondanzio, Dallas, TX (US); Christopher Scoville, Burlington, VT (US)

(72) Inventors: David Richard Abbondanzio, Dallas, TX (US); Christopher Scoville, Burlington, VT (US)

(21) Appl. No.: 19/236,895

(22) Filed: Jun. 12, 2025

Related U.S. Application Data
(60) Provisional application No. 63/659,258, filed on Jun. 12, 2024.

(51) Int. Cl. G06N 3/065; G06N 3/084

(52) U.S. Cl. CPC G06N 3/065; G06N 3/084

(57) ABSTRACT

An analog or mixed-signal ASIC implements and trains a neural-network model entirely in the analog domain. Weights and activations are encoded as pulse frequencies. Forward propagation is performed by analog multipliers, while reverse-propagation error signals are conveyed through reverse directional nodes and error neurons that inject pulse-based corrections upstream, eliminating digital gradient arithmetic. Variable analog weight-storage elements—including field-effect transistors, switched-capacitor arrays, and phase-change memory—are updated in real time. Additional features include flash-ADC calibration with temperature compensation, auto-associative pattern completion, stochastic-computing variants, dynamic gate-array reconfiguration, and optional wireless telemetry. Continuous on-edge learning is achieved at ultra-low power for sensor-rich edge-AI applications.

### BACKGROUND OF THE INVENTION

### Field of the Invention

The present disclosure relates to artificial-intelligence hardware and, more particularly, to analog or mixed-signal application-specific integrated circuits (ASICs) that implement and train neural-network models using pulse-frequency representations.

### Description of Related Art

Digital neural-network accelerators perform trillions of multiply-accumulate operations, moving large arrays of weights between off-chip memory and compute cores and thereby consuming significant power. Analog-in-memory approaches reduce energy by collocating storage and multiplication, yet most still rely on digital back-propagation performed off-chip or in a companion processor. No known solution provides a single semiconductor die that (i) stores synaptic weights in purely analog form, (ii) performs both inference and training on-edge using pulse-frequency arithmetic, and (iii) allows live reconfiguration of network topology without system reset. The present invention addresses these shortcomings.

### BRIEF SUMMARY OF THE INVENTION

An analog or mixed-signal ASIC is disclosed that encodes all neuron activations and synaptic weights as pulse frequencies. Forward propagation occurs through analog multipliers; reverse-propagation error information is conveyed by reverse directional nodes and error neurons, eliminating digital gradient arithmetic. Variable analog weight-storage elements-including field-effect transistors (FETs), switched-capacitor arrays, and phase-change memory—are updated in real time from the error pulses. Additional aspects include flash-ADC calibration with temperature compensation, auto-associative pattern completion, stochastic-computing variants, dynamic gate-array reconfiguration, and optional wireless telemetry. Continuous on-the-fly learning is thus achieved at ultra-low power for edge-AI deployments.

### BRIEF DESCRIPTION OF THE SEVERAL VIEWS OF THE DRAWING(S)

FIG. 1 is a top-level block diagram of an analog pulse-frequency neural-network ASIC that includes a sensor interface, pulse-frequency encoder, core analog compute fabric and calibration engine.

FIG. 2 is a combined forward- and reverse-propagation schematic showing analog multipliers and integrators, reverse directional nodes that carry error pulses, and neuron-level details of the activation circuit and weight-update element.

FIG. 3 is an auto-associative pattern-completion circuit in which a partial pulse-frequency input is correlated against template storage to reconstruct a full output.

FIG. 4 illustrates dynamic topology reconfiguration of islanded neural-network modules using on-chip analog switches that form a new interconnect pattern without system reset.

### DETAILED DESCRIPTION OF THE INVENTION

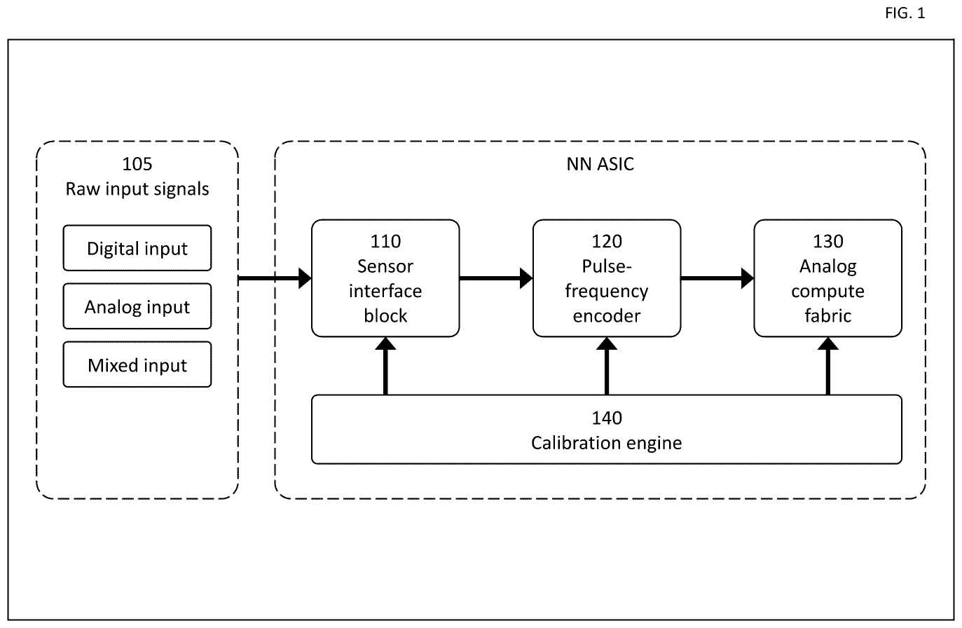

### Overall Architecture (FIG. 1)

Raw signal values 105 from one or more sensors (e.g., image arrays, inertial units, tactile grids, or RF front-ends) enter the device through a sensor-interface block 110. The sensor-interface block performs any requisite buffering, level-shifting, or analog-to-digital conversion and forwards the resulting data to a pulse-frequency encoder 120. External input data may originate from analog sensors, digitized sensor streams, or purely computational sources such as an on-die arithmetic unit or an off-chip processor; for brevity these diverse signal sources are referred to collectively herein as “sensor inputs.” The encoder 120 converts each incoming value into a pulse train whose frequency encodes the magnitude of the input before the train is injected into the analog computation fabric 130. A calibration engine 140 is used to keep the system consistent.

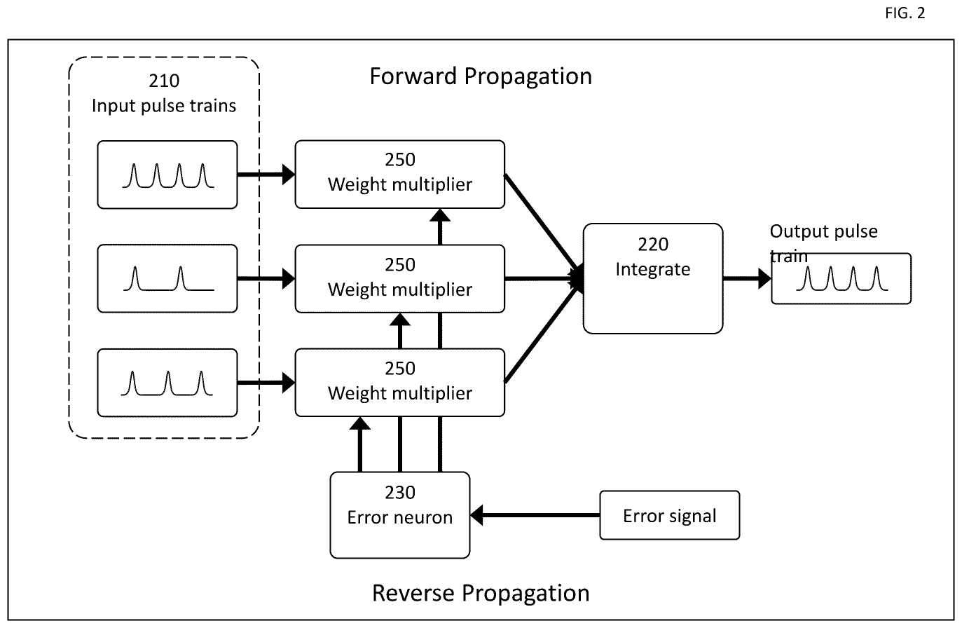

### Forward and Reverse Propagation (FIG. 2)

Input pulse trains 210 traverse analog multipliers and integrators 220 to produce an output pulse stream. At the output layer, an analog comparator (not shown) generates an error-pulse train routed into error neuron 230. Reverse directional node 240 propagates the error upstream; weight-storage element 250 (e.g., a variable FET) adjusts its conductance in proportion to the error-pulse frequency. The upper half of FIG. 2 depicts forward propagation, while the lower half depicts reverse propagation with non-overlapping timing-replacing the separate timing diagram.

In one embodiment the activation circuit incorporates a waveform generator capable of emitting any of several stored pulse shapes—e.g., rectangular, trapezoidal, Gaussian, exponentially decaying, or doublet pulses—held in a non-volatile on-chip library. A control register bank allows firmware to assign a specific pulse profile to each computational module, to an entire layer, or to the network as a whole, so that the chosen shape modulates duty-cycle or rise-time characteristics of the pulse train and thereby tunes the weight-update relationship between connected neurons.

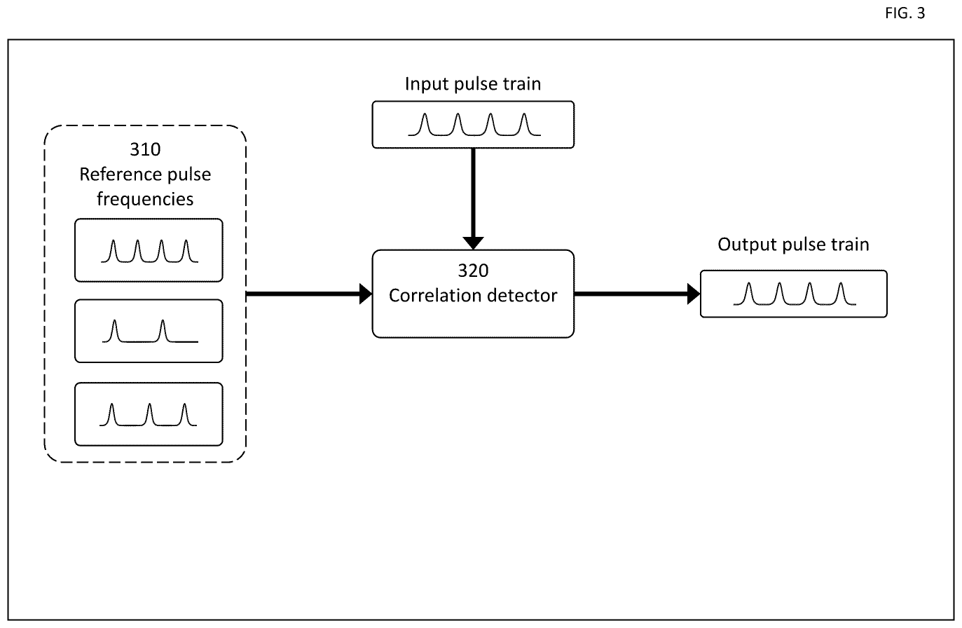

### Auto-Associative Pattern Completion (FIG. 3)

Template storage cells 310 store reference pulse frequencies. Correlation detector 320 compares a partial input against these templates and, upon exceeding threshold T, outputs a reconstructed pulse-frequency train representative of the closest stored pattern.

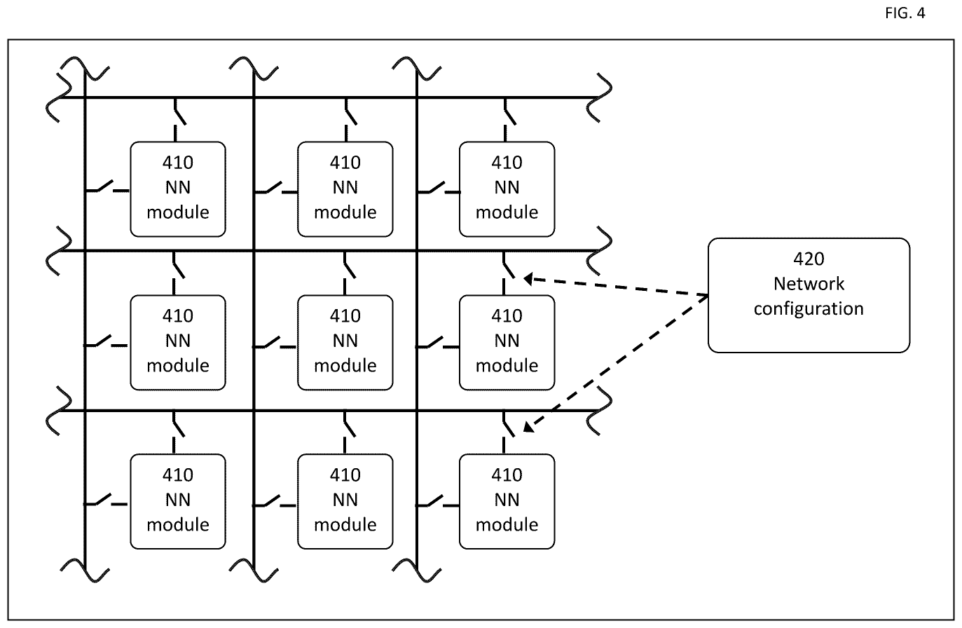

### Dynamic Topology Reconfiguration (FIG. 4)

Islanded NN modules 410 are linked by coarse-grain interconnects. Switches disconnect a first subset of modules and reconnect a second subset according to a configuration setup 420 forming a new interconnect pattern without clearing neuron state, after which on-edge training resumes instantly.

### Alternative Embodiments

In some variants the numeric representation is stochastic, using random pulse streams whose density encodes probabilities. In others, convolution layers are replaced by recurrent networks. All such variations remain within the scope of the appended claims.

1. A method of operating an analog neural-network applications-specific integrated circuit (ASIC), the method comprising:
(a) representing each synaptic weight and neuron activation as a frequency of electrical pulses;
(b) generating forward-propagation signals by modulating said pulse frequencies through analog multiplication stages;
(c) generating reverse-propagation error signals via reverse directional nodes that propagate error pulses backward through the network without executing conventional digital back-propagation arithmetic;
(d) adjusting each synaptic weight in real time by directly modifying a corresponding analog parameter selected from the group consisting of voltage, capacitance, conductance, current, or resistance based on at least one of amplitude, frequency, or duty-cycle of the received error pulses; and
(e) continually updating network parameters on-edge to support on-the-fly learning with reduced energy consumption compared with digital implementations.

2. The method of claim 1, wherein the reverse directional nodes comprise error neurons configured to invert and attenuate the error-pulse train before routing the error pulses into upstream layers.

3. The method of claim 1, wherein each weight-storage element is realized as a field-effect transistor operating in its linear region, a switched-capacitor cell, or a phase-change memory element whose conductance is incrementally adjusted by the error pulses.

4. The method of claim 1, further comprising dynamically re-routing pulse-frequency signals through a plurality of islanded computational modules by actuating on-chip analog switches, thereby altering network topology without a system reset.

5. The method of claim 1, wherein the network continues to learn in real time during sensor data ingestion, inference, and topology re-configuration such that no discrete training phase is required.

6. The method of claim 1, further comprising selecting, for at least one of an individual computational module, a layer, or an entire network instance, an activation-pulse profile from a library of predefined pulse shapes, the selected pulse shape modifying at least one time-domain characteristic of the pulse train and thereby altering a learning-rate relation between interconnected neurons.

7. An analog neural-network ASIC comprising:
(a) a plurality of islanded computational modules;
(b) a pulse-frequency encoder that converts analog or digital external input data—including values originating from physical sensors, digitized sensor streams, or purely computational sources—into corresponding analog pulse trains;
(c) an analog multiplier array within each module that multiplies incoming pulse-frequency signals by local analog weights;
(d) reverse directional nodes coupled to the multiplier array and configured to propagate error-representative pulse trains upstream without digital computation of weight corrections;
(e) a weight-adjustment circuit including analog storage elements selected from variable resistors, variable capacitors, field-effect transistors, or phase-change memory cells, each element being updated in real time by the frequency or duty-cycle of the associated error pulses;
(f) an interconnect network that couples the islanded computational modules such that pulse-frequency signals propagate between modules; and
(g) a pulse-frequency decoder that converts final network outputs to digital form;
wherein the ASIC performs inference and on-chip training without employing a regular row-and-column cross-bar array and without any digital processor that calculates per-synapse change in weight values.

8. The ASIC of claim 7, wherein the interconnect network comprises a programmable matrix of analog switches that selectively couples the islanded computational modules to one another.

9. The ASIC of claim 7, wherein each computational module further comprises an analog integrator that sums incoming pulse-frequency signals, an activation circuit configured to apply a selectable activation function, a weight-storage element realized as at least one of a variable resistor, variable capacitor, or phase-change memory cell, and a reverse directional node that injects an error pulse into the integrator without digital computation.

10. The ASIC of claim 7, wherein the reverse directional nodes invert and attenuate the error-pulse train before injection into an upstream integrator.

11. The ASIC of claim 7, further comprising an input interface block having analog-to-digital converters, a processing block formed by a tiled array of the computational modules, a memory block including an embedded phase-change memory array for non-volatile storage of learned analog weights, and an output interface block that converts output pulse trains into digital bus signals.

12. The ASIC of claim 7, wherein the processing block implements a multi-layer perceptron architecture in hardware and includes a power-management subsystem that selectively shuts down unused portions to conserve energy.

13. The ASIC of claim 7, further comprising a digital monitoring subsystem that includes flash analog-to-digital converter channels configured to sample analog capacitor voltages at predetermined intervals and a microcontroller configured to adjust on-chip trimming networks based on the sampled voltages.

14. The ASIC of claim 7, wherein the activation circuit of each computational module is configured to generate pulse trains having a selectable pulse shape chosen from a library stored on-chip, the pulse shape being independently programmable for each module, for each network layer, or globally for the entire network.

15. A method for dynamic network topology reconfiguration in an analog neural-network ASIC, comprising:
(a) partitioning the ASIC into a plurality of islanded computational modules arranged in a coarse-grain gate-array fabric;
(b) upon receipt of a reconfiguration command, electrically disconnecting a first subset of modules from existing interconnect lines and connecting a second subset of modules into a new interconnect pattern via on-chip programmable analog switches;
(c) synchronizing pulse-frequency clocks and activating the newly formed interconnects to propagate forward and reverse pulses according to the updated topology; and
(d) resuming on-edge training using the reconfigured network without requiring system-level reset or external digital reprogramming.

16. The method of claim 15, further comprising reassigning weight-storage elements selected from switched-capacitor arrays or variable field-effect transistor arrays to new neuron pairings contemporaneously with the reconfiguration.

17. The method of claim 15, wherein training resumes immediately after reconfiguration by continuing to route error-encoded pulse trains through the updated interconnects without flushing stored neuron states.

18. A method of auto-associative learning in an analog neural-network ASIC, comprising:
(a) storing a plurality of training patterns as native pulse-frequency templates within a first group of analog storage elements;
(b) presenting a partial or noisy version of a previously stored training pattern as an input encoded into pulse trains;
(c) propagating the input pulses through a plurality of auto-associative circuits that detect pattern correlations by comparing incoming pulse frequencies against the stored frequency templates; and
(d) reconstructing a full pattern output as a pulse-frequency train that corresponds to a closest stored template.

19. The method of claim 18, wherein pattern correlation is detected by analog comparators and integrators that integrate a difference between incoming pulse frequency and the stored template frequency.

20. The method of claim 18, further comprising reinforcing matching analog weights by increasing gain of weight field-effect transistors through adjustment of gate-to-source voltage whenever a correlation threshold is exceeded.
